(19) United States
(12) Patent Application Publication
(10) Pub. No.: US 2023/0222780 A1
(43) Pub. Date: Jul. 13, 2023

(54) VEHICLE IDENTIFICATION DEVICE

(71) Applicant: Mitsubishi Electric Corporation, Tokyo (JP)

(72) Inventors: Tetsuro NISHIOKA, Tokyo (JP); Takuya TANIGUCHI, Tokyo (JP)

(73) Assignee: Mitsubishi Electric Corporation, Tokyo (JP)

(21) Appl. No.: 18/078,182

(22) Filed: Dec. 9, 2022

(30) Foreign Application Priority Data
Jan. 12, 2022 (JP) 2022-002732

(51) Int. Cl. G06V 10/80

(52) U.S. Cl. CPC G06V 10/803

(57) ABSTRACT

An object herein is to provide a vehicle identification device by which the relation of a towing vehicle and a towed vehicle is accurately determined and stored. A vehicle identification device includes: a vehicle information acquisition unit for acquiring vehicle information indicative of positions, traveling directions and traveling speeds of multiple vehicles; a towing relation determination unit for extracting, from the vehicle information acquired by the vehicle information acquisition unit, a vehicle train that is a succession of vehicles, to thereby determine that a leading vehicle in the vehicle train is a towing vehicle and a portion of the vehicle train subsequent to the towing vehicle is at least one towed vehicle towed by the towing vehicle; and a towing relation storing unit for storing a towing relation represented by the towing vehicle and the at least one towed vehicle determined by the towing relation determination unit.

### TECHNICAL FIELD

The present application relates to a vehicle identification device.

### BACKGROUND

There has been proposed a technique in which vehicles and obstacles are detected by use of an object detection sensor and the detection result is applied to vehicle automatic driving or collision avoidance. Examples of the vehicles include, other than a single vehicle traveling alone, a towing vehicle and a vehicle to be towed by the towing vehicle. Further, a demonstration test has been performed with respect to a towing vehicle that is automatically traveling while towing the to-be-towed vehicle. For such vehicle control, it is required to detect positions, traveling directions, traveling speeds, etc. of these vehicles, to thereby recognize the relation of the towing vehicle and the towed vehicle.

A traveling control system is disclosed in which the size of the towed vehicle is detected from an image captured by a camera mounted on the towing vehicle, to thereby recognize the relation of the towing vehicle and the towed vehicle. Recognition of the size of the towed vehicle makes it possible to perform traveling control for avoiding the towed vehicle from making contact with an obstacle (see, for example, Patent Document 1).

### CITATION LIST

### Patent Literature

Patent Document 1: Japanese Patent Application Laid-open No. 2019-147459

According to the technique disclosed in Patent Document 1, a sensor, such as a LiDAR (Light Detection And Ranging) sensor of an optical detection and ranging type, a camera or the like, is provided on the towing vehicle, and the size of the towed vehicle is recognized on the basis of information detected by that sensor. However, such cases are conceivable where, on the basis of the information detected by the sensor, the towing vehicle makes recognition with confusion between the towed vehicle and an obstacle. Further, when there is a plurality of vehicle trains each composed of a towing vehicle and at least one towed vehicle towed by the towing vehicle, and these vehicle trains are in a state of traveling closely to each other, such cases are conceivable where confusion occurs in recognizing a towing relation among the towing vehicles and the towed vehicles.

### SUMMARY

An object of this application is to provide a vehicle identification device by which the relation of the towing vehicle and the towed vehicle is accurately determined and stored.

A vehicle identification device according to this application comprises:

a vehicle information acquisition unit for acquiring vehicle information indicative of positions, traveling directions and traveling speeds of multiple vehicles;

a towing relation determination unit for extracting, from the vehicle information acquired by the vehicle information acquisition unit, a vehicle train that is a succession of vehicles, to thereby determine that a leading vehicle in the vehicle train is a towing vehicle and a portion of the vehicle train subsequent to the towing vehicle is at least one towed vehicle towed by the towing vehicle; and

a towing relation storing unit for storing a towing relation represented by the towing vehicle and said at least one towed vehicle determined by the towing relation determination unit.

By the vehicle identification device according to this application, it is possible to extract the vehicle train from the vehicle information indicative of positions, traveling directions and traveling speeds of the multiple vehicles, to thereby accurately determine and store the towing relation of the towing vehicle and the towed vehicle in that vehicle train.

### BRIEF DESCRIPTION OF DRAWINGS

FIG. 1 is a configuration diagram of a vehicle tracking system including a vehicle identification device according to Embodiment 1.

FIG. 2 is a functional block diagram of the vehicle identification device according to Embodiment 1.

FIG. 3 is a hardware configuration diagram of the vehicle identification device according to Embodiment 1.

FIG. 4 is a diagram for explaining how the vehicle identification device according to Embodiment 1 extracts a vehicle train and determines a towing relation.

FIG. 5 is a flowchart showing operations of the vehicle identification device according to Embodiment 1.

FIG. 6 is a diagram for explaining how a vehicle identification device according to Embodiment 2 extracts a vehicle train and determines a towing relation.

FIG. 7 is a graph showing towing relations between towing vehicles and towed vehicles, determined by the vehicle identification device according to Embodiment 2.

FIG. 8 is a diagram for explaining how a vehicle identification device according to Embodiment 3 extracts a vehicle train and determines a towing relation.

FIG. 9 is a functional block diagram of a vehicle identification device according to Embodiment 4.

FIG. 10 is a diagram for explaining how the vehicle identification device according to Embodiment 4 extracts a vehicle train and determines a towing relation.

FIG. 11 is a flowchart showing operations of the vehicle identification device according to Embodiment 4.

FIG. 12 is a diagram for explaining how a vehicle identification device according to Embodiment 5 extracts a vehicle train and determines a towing relation.

FIG. 13 is a diagram for explaining how a vehicle identification device according to Embodiment 6 extracts a vehicle train and determines a towing relation.

### DESCRIPTION OF EMBODIMENTS

### 1. Embodiment 1

<Configuration of Vehicle Tracking System>

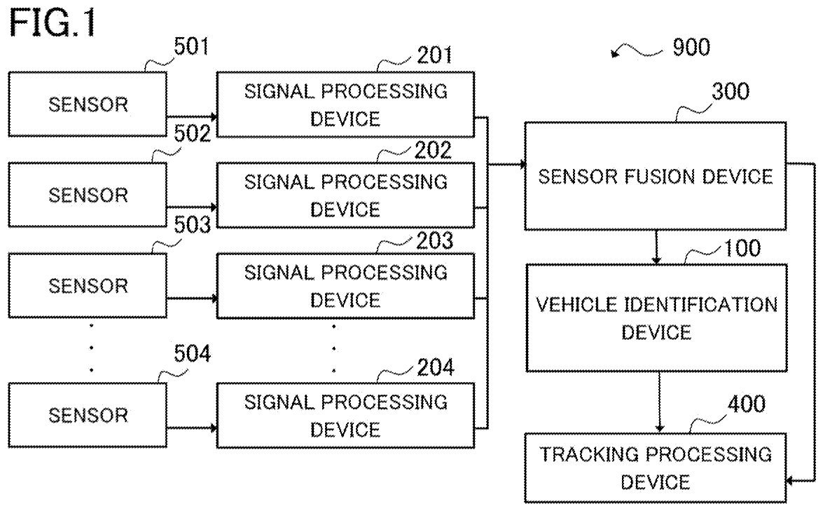

FIG. 1 is a configuration diagram of a vehicle tracking system 900 including a vehicle identification device 100 according to Embodiment 1. The vehicle tracking system 900 is a system for recognizing traveling states of multiple vehicles and tracking the respective vehicles so that no confusion occurs between them. By the vehicle tracking system 900, it is possible to accurately recognize the positions of the respective vehicles during traveling, to thereby predict their traveling courses. This makes it possible to output information required for automatic driving of each of the vehicles and the vehicle group thereof.

Sensors 501, 502, 503 and 504 are sensors of the same type or different types for detecting the respective vehicles and the obstacles. As each of the sensors, an LiDAR sensor that detects a direction and a distance to an object by using light, a camera that captures an image, a radar that detects a direction and a distance to a surrounding object by using an electric wave, an ultrasonic sensor that detects a distance to a short-range object, or the like, may be included. Further, the sensors 501, 502, 503, 504 may include other sensors incorporated in a host vehicle, such as a vehicle speed sensor, an acceleration sensor, a yaw-rate sensor (angular acceleration sensor) and the like, or a GPS (Global Positioning System) or like device capable of recognizing the position of the host vehicle.

The sensor output signals of these sensors 501, 502, 503, 504 are subjected to signal processing by signal processing devices 201, 202, 203 and 204, respectively. In FIG. 1, four sensors 501 to 504 and four signal processing devices 201 to 204 are shown as an example; however, the number of such sensors and the number of such signal processing devices are each not limited to four.

Data resulting from signal processing by the signal processing devices 201, 202, 203, 204 are transferred to a sensor fusion device 300. The sensor fusion device 300 fuses these data as processed signals of the sensors of the same type or different types, and outputs vehicle information and obstacle information, such as, positions, moving directions, moving speeds of vehicles and obstacles.

The vehicle identification device 100 acquires the vehicle information and the obstacle information from the sensor fusion device 300. The vehicle identification device 100 extracts from the vehicle information, a vehicle train that is a succession of vehicles, and determines that a leading vehicle in the vehicle train is a towing vehicle and the portion of the vehicle train subsequent to the towing vehicle is at least one towed vehicle, so that a towing relation represented by the towing vehicle and said at least one towed vehicle in the vehicle train is determined and stored. The vehicle identification device 100 outputs information about the towing relation between the towing vehicle and said at least one towed vehicle, to a tracking processing device 400. On the basis of the information about the towing relation outputted by the vehicle identification device 100, as well as the vehicle information and the obstacle information outputted by the sensor fusion device 300, the tracking processing device 400 accurately tracks the respective vehicles during traveling while preventing confusion between them, and predicts their respective traveling courses.

Here, although the sensors 501, 502, 503, 504 may be those mounted on the respective vehicles, they may be fixed sensors located along a road or at intersections. Further, although a place on which the vehicles are traveling may be a road such as a local road, an automobile road, a free way or the like, the place may be other than the road, such as a part transport passage in a factory, a runway in an airport, or the like. Although the towing vehicle and the towed vehicle may be a tractor and a trailer which are traveling on a local road, they may be a car puller and an article-transport carriage which are running on a private land.

For vehicle automatic driving, a technology of “V2X” (Vehicle To Everything) has been proposed in which outputs of on-vehicle sensors and on-road sensors are fused together, so that communication connections between the vehicle and everything else are taken into consideration. Further, technologies related to “V2V” (Vehicle To Vehicle), “V2I” (Vehicle To Infrastructure), “V2N” (Vehicle To Network) and “V2P” (Vehicle To People) that are individually extracted from “V2X” have been proposed. The vehicle identification device according to this application may employ any one of these technologies.

<Function Block Diagram of Vehicle Identification Device>

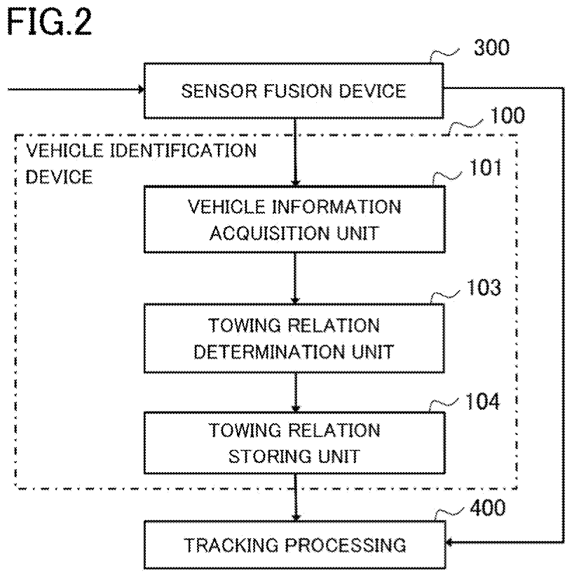

FIG. 2 is a function block diagram of the vehicle identification device 100 according to Embodiment 1. In the vehicle identification device 100, a vehicle information acquisition unit 101, a towing relation determination unit 103 and a towing relation storing unit 104 are provided. The vehicle information acquisition unit 101 acquires traveling information indicative of positions, traveling directions and traveling speeds of multiple vehicles, from the sensor fusion device 300. The towing relation determination unit 103 extracts a vehicle train from the traveling information of the multiple vehicles, to thereby determine that a leading portion in the vehicle train is a towing vehicle and the subsequent portion of the vehicle train is at least one towed vehicle. Further, it causes the towing relation storing unit 104 to store such a towing relation. The towing relation storing unit 104 outputs the thus-stored towing relation to the tracking processing device 400.

<Hardware Configuration of Vehicle Identification Device>

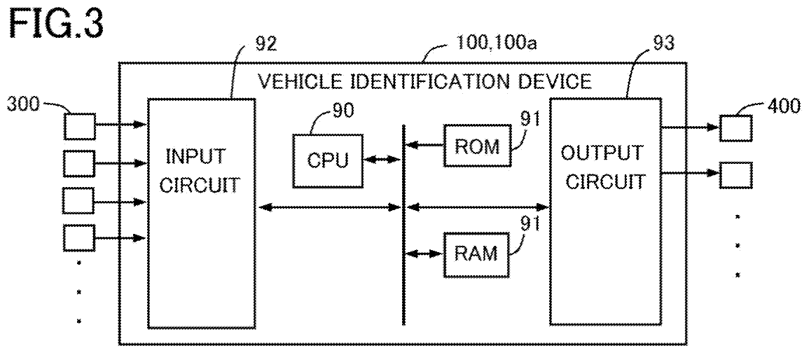

FIG. 3 is a hardware configuration diagram of the vehicle identification device 100. Although the hardware configuration diagram of FIG. 3 may also be applied to a vehicle identification device 100a to be described later, in the following, description will be made about the vehicle identification device 100 as a representative. In this Embodiment, the vehicle identification device 100 is an electronic control device for determining a towing relation in multiple vehicles. The respective functions of the vehicle identification device 100 are implemented by a processing circuit included in the vehicle identification device 100. Specifically, the vehicle identification device 100 includes as the processing circuit: an arithmetic processing device 90 (computer) such as a CPU (Central Processing Unit) or the like; storage devices 91 for performing data transactions with the arithmetic processing device 90; an input circuit 92 for inputting external signals to the arithmetic processing device 90; an output circuit 93 for externally outputting signals from the arithmetic processing device 90; and the like.

As the arithmetic processing device 90, there may be included an ASIC (Application Specific Integrated Circuit), an IC (Integrated Circuit), a DSP (Digital Signal Processor), an FPGA (Field Programmable Gate Array), any one of a variety of logic circuits, any one of a variety of signal processing circuits, or the like. Further, multiple arithmetic processing devices 90 of the same type or different types may be included so that the respective parts of processing are executed in a shared manner. As the storage devices 91, there are included a RAM (Random Access Memory) that is configured to allow reading and writing of data by the arithmetic processing device 90, a ROM (Read Only Memory) that is configured to allow reading of data by the arithmetic processing device 90, and the like. As the storage device 91, a non-volatile or volatile semiconductor memory, such as a flash memory, an EPROM, an EEPROM or the like, may be used. The input circuit 92 includes A-D converters, a communication circuit, etc. to which output signals of a variety of sensors and switches including the sensor fusion device 300, and a communication line, are connected, and which serve to input these output signals of the sensors and switches, and communication information, to the arithmetic processing device 90. The output circuit 93 includes a driver circuit, a communication circuit, etc. for outputting control signals from the arithmetic processing device 90 to a device including the tracking processing device 400.

The respective functions provided by the vehicle identification device 100 are implemented in such a manner that the arithmetic processing device 90 executes software (programs) stored in the storage device 91 such as the ROM or the like, to thereby cooperate with the other hardware in the vehicle identification device 100, such as the other storage device 91, the input circuit 92, the output circuit 93, etc. Note that the set data of threshold values, determination values and the like to be used by the vehicle identification device 100 is stored, as a part of the software (programs), in the storage device 91 such as the ROM or the like. Although each of the functions that the vehicle identification device 100 has, may be established by a software module, it may be established by a combination of software and hardware.

<Extraction of Vehicle Train and Determination of Towing Relation>

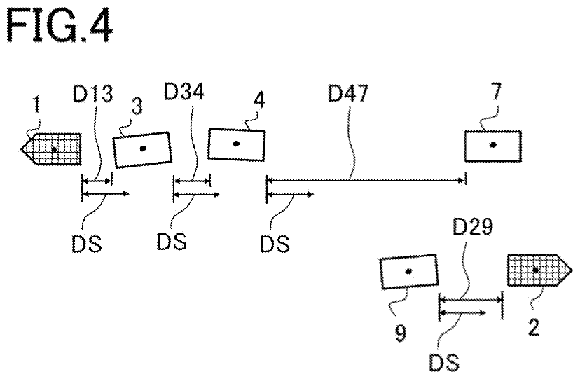

FIG. 4 is a diagram for explaining how the vehicle identification device 100 according to Embodiment 1 extracts a vehicle train and determines a towing relation. The vehicle identification device 100 receives from the sensor fusion device 300, traveling information about vehicles 1, 2, 3, 4, 7, 9 including their respective positions, traveling directions and traveling speeds, and then extracts a vehicle train as a succession of vehicles.

In FIG. 4, it is assumed that the vehicles 1, 3, 4, 7 form a succession and the vehicles 2, 9 form another succession. This is because the respective vehicles in each succession are arranged serially in a common direction and within a specified range. Here, the succession of the vehicles 1, 3, 4, 7 will be investigated as a first vehicle train. According to the investigation of the traveling direction of the first vehicle train, the traveling direction is leftward in FIG. 4 and the vehicle 1 is a leading vehicle. Thus, it is possible to determine that the vehicle 1 is a towing vehicle and the vehicles 3, 4, 7 as the subsequent portion of the first vehicle train are towed vehicles. Since the vehicle 3 is positioned just behind the vehicle 1, the vehicle 3 is a towed vehicle 3 towed by the towing vehicle 1. Since the vehicle 4 is positioned just behind the towed vehicle 3, the vehicle 4 is a second towed vehicle 4 towed by the towed vehicle 3. Since the vehicle 7 is positioned just behind the second towed vehicle 4, the vehicle 7 is a third towed vehicle 7 towed by the second towed vehicle 4.

Likewise, the succession of the vehicles 2, 9 will be investigated as a second vehicle train. According to the investigation of the traveling direction of the second vehicle train, the traveling direction is rightward in FIG. 4 and the vehicle 2 is a leading vehicle. Thus, the vehicle 2 is a towing vehicle and the vehicle 9 as the subsequent portion of the second vehicle train is a towed vehicle. The vehicle 9 is the towed vehicle 9 towed by the towing vehicle 2.

It is not necessary to regard such vehicles which are serially arranged in nearly the same directions but do not form a succession, as a vehicle train. These vehicles may be regarded as vehicles which are traveling independently of each other, with no towing relation therebetween.

The towing relation in the multiple vehicles is determined in this manner and then stored. This makes it easy to perform tracking processing of the respective vehicles. Clarifying a towing relation between specific vehicles makes it possible to prevent the towed vehicle from being recognized in a confused manner as an obstacle for the towing vehicle. Further, when priority is given to the towing relation that was once stored, even if a plurality of vehicle trains is in a state of traveling closely to each other, it is possible to suppress occurrence of confusion in the towing relation. Furthermore, when the respective vehicles are tracked on the basis of the stored towing relation, it becomes less likely to lose trace of each of the vehicles. In addition, when the respective vehicles are tracked on the basis of the stored towing relation, it becomes easy to predict the future traveling course of each of the vehicles.

<Determination of Towing Relation by Using Inter-vehicle Distance>

Here, an additional condition may be used to determine a towing relation of vehicles in a vehicle train. With respect to front and rear vehicles, the rear vehicle may be determined to be towed by the front vehicle when an inter-vehicle distance therebetween is not more than a predetermined towing distance DS.

In FIG. 4, inter-vehicle distances between the respective vehicles 1, 3, 4, 7 as the first vehicle train will be investigated. An inter-vehicle distance D13 between the vehicle 1 and the vehicle 3 is a distance between the rear end of the vehicle 1 and the front end of the vehicle 3. An inter-vehicle distance D34 between the vehicle 3 and the vehicle 4 is a distance between the rear end of the vehicle 3 and the front end of the vehicle 4. An inter-vehicle distance D47 between the vehicle 4 and the vehicle 7 is a distance between the rear end of the vehicle 4 and the front end of the vehicle 7.

These inter-vehicle distances are compared with the towing distance DS. If the inter-vehicle distance is within the towing distance DS, it is possible to determine that the rear vehicle is towed by the front vehicle. If the inter-vehicle distance is more than the towing distance DS, it is possible to determine that the rear vehicle is not towed by the front vehicle and is traveling independently of the front vehicle.

In the first vehicle train, relative to the position of the leading vehicle 1, the position of the vehicle 3 behind is within the towing distance DS, so that the inter-vehicle distance D13 is not more than the towing distance DS. Thus, it is possible to determine that the vehicle 3 is a towed vehicle towed by the towing vehicle 1. In the first vehicle train, relative to the position of the towed vehicle 3, the position of the vehicle 4 behind is within the towing distance DS, so that the inter-vehicle distance D34 is not more than the towing distance DS. Thus, it is possible to determine that the vehicle 4 is a towed vehicle towed by the towed vehicle 3. In the first vehicle train, relative to the position of the towed vehicle 4, the position of the vehicle 7 behind is not within the towing distance DS, so that the inter-vehicle distance D47 is more than the towing distance DS. Thus, it is possible to determine that the vehicle 7 is not a towed vehicle towed by the towed vehicle 4.

Likewise, in the second vehicle train, relative to the position of the leading vehicle 2, the position of the vehicle 9 behind is not within the towing distance DS, so that the inter-vehicle distance D29 is more than the towing distance DS. Thus, it is possible to determine that the vehicle 9 is not a towed vehicle towed by the leading vehicle 2.

Since whether or not a rear vehicle is towed by a front vehicle is determined depending on whether or not the inter-vehicle distance is not more than the towing distance DS, it is possible to determine the towing relation more accurately. In this manner, a towing relation in the multiple vehicles is more accurately determined and then stored. This makes it easier to perform tracking processing of the respective vehicles. More accurately determining a towing relation between specific vehicles makes it possible to prevent an independent vehicle which is traveling just incidentally behind the front vehicle from being recognized in a confused manner as a towed vehicle.

The towing distance DS may be determined through actual measurement of a distance between actual vehicles connected in a towing state. When a part-transport carriage in a factory is assumed to be a target vehicle, the towing distance DS may be set to 0.5 meter, for example.

In FIG. 4, the inter-vehicle distance between front and rear vehicles is defined as a distance between the rear end of the front vehicle and the front end of the rear vehicle. However, the inter-vehicle distance may be defined as a distance between the center position of the front vehicle and the center position of the rear vehicle.

<Determination and Storage of Towing Relation during Stopping>

A towing relation of vehicles in a vehicle train may be determined only when the vehicle train is in a stopped state. Instead, the towing relation storing unit may store the towing relation when the vehicle train is in a stopped state. This is because there is no need to assume that the towing relation in the vehicle train is released for separation during traveling. In addition, there is no need to assume that a towing relation is newly added in the vehicle train during traveling.

When determination of the towing relation or storage of the towing relation is executed only during stopping of the vehicle train, it is allowed that the determination or storage of the towing relation is performed carefully over time. This results in improving the reliability of the vehicle identification device 100. Further, since the determination or storage of the towing relation in the vehicle train is suspended in the traveling state, it is possible to reduce the processing load of the vehicle identification device 100.

<Operations of Vehicle Identification Device>

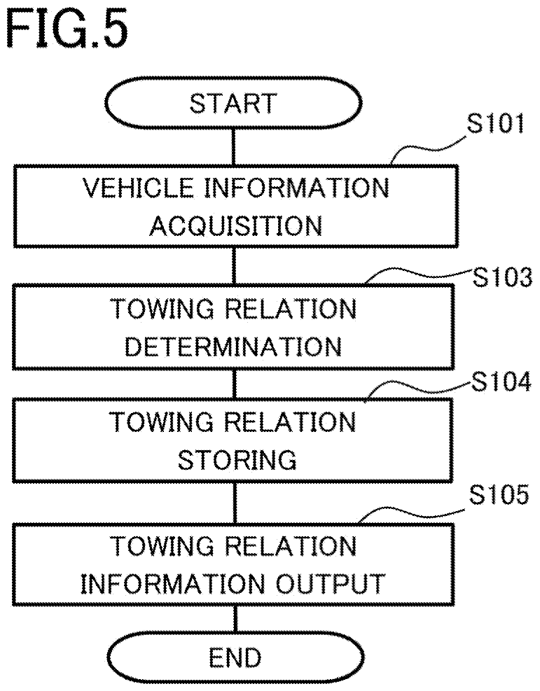

FIG. 5 is a flowchart showing operations of the vehicle identification device 100 according to Embodiment 1. The operations shown in FIG. 5 are executed every fixed period of time (for example, every 1 ms). It is allowed that the operations shown in FIG. 5 are not executed every fixed period of time but executed at every occurrence of a specified event, such as, at every signal input from the vehicle speed sensor in the vehicle. How the operations shown in the flowchart of FIG. 5 are executed by the vehicle identification device 100 will be described below.

With the start of the operations, in Step S101, the vehicle information acquisition unit 101 acquires traveling information indicative of positions, traveling directions and traveling speeds of the multiple vehicles, from the sensor fusion device 300. Then, in Step S103, the towing relation determination unit 103 extracts a vehicle train from the traveling information of the multiple vehicles, to thereby determine that a leading portion in the vehicle train is a towing vehicle and the subsequent portion of the vehicle train is at least one towed vehicle towed by the towing vehicle. At this time, the towing relation determination unit may determine such a towing relation by additionally taking into account an inter-vehicle distance.

In Step S104, the towing relation determination unit 103 causes the towing relation storing unit 104 to store such a towing relation. In Step S105, the towing relation storing unit 104 outputs the thus-stored towing relation, as towing relation information, to the tracking processing device 400. Thereafter, the operations are terminated.

### 2. Embodiment 2

<Towed-Vehicle Placeable Fan-Shaped Region>

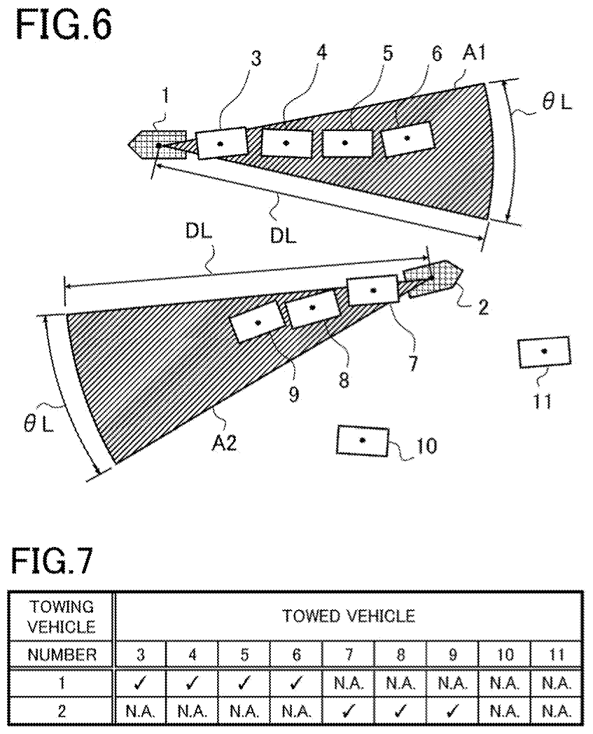

FIG. 6 is a diagram for explaining how a vehicle identification device 100 according to Embodiment 2 extracts a vehicle train and determines a towing relation. Here, since the vehicle identification device according to Embodiment 2 can be implemented by changing the software of the vehicle identification device according to Embodiment 1, the reference numeral 100 is also used without change for the vehicle identification device. However, the vehicle identification device according to Embodiment 2 may be implemented with a hardware change.

The vehicle identification device 100 according to Embodiment 2 determines a towing relation about a vehicle which is placed in a towed-vehicle placeable region behind the towing vehicle. The towed-vehicle placeable region is a region within a predetermined vehicle-train distance DL behind the towing vehicle and in a predetermined angular range θL behind the towing vehicle.

In FIG. 6, a vehicle train is shown that is formed of a towing vehicle 1 and vehicles 3, 4, 5, 6 behind the towing vehicle 1. A towed-vehicle placeable region A1 that is within the vehicle-train distance DL behind the towing vehicle 1 and that is defined by the angular range θL behind the towing vehicle 1, is shown as a fan-shaped region. The determination of a towing relation is made about a vehicle which is placed in the towed-vehicle placeable region A1.

The vehicle-train distance DL and the angular range θL may be determined through actual measurement of vehicle-train distances and angular ranges that may be taken by a vehicle train actually having a connection in a towing state. For example, the vehicle-train distance DL may be set to 50 meters, and the angular range θL may be set to 30 degrees.

As shown here, the towed-vehicle placeable region A1 may be a region that is within the vehicle-train distance DL from the vehicle center position of the towing vehicle 1 and that is defined by the angular range θL behind the vehicle center position of the towing vehicle 1. In this case, the determination of a towing relation is made about a vehicle whose center position is placed in the towed-vehicle placeable region A1.

Likewise, in FIG. 6, another vehicle train is shown that is formed of a towing vehicle 2 and vehicles 7, 8, 9 behind the towing vehicle 2. A towed-vehicle placeable region A2 that is within the vehicle-train distance DL behind the towing vehicle 2 and that is defined by the angular range θL behind the towing vehicle 2, is shown as a fan-shaped region. The determination of a towing relation is made about a vehicle which is placed in the towed-vehicle placeable region A2.

The towed-vehicle placeable region A2 may be a region that is within the vehicle-train distance DL from the vehicle center position of the towing vehicle 2 and that is defined by the angular range θL behind the vehicle center position of the towing vehicle 2. In this case, the determination of a towing relation is made about a vehicle whose center position is placed in the towed-vehicle placeable region A2.

In the determination of a towing relation, for example, if the inter-vehicle distance between a front vehicle and a rear vehicle is within the towing distance DS, the rear vehicle may be determined to be towed by the front vehicle. This makes it possible to determine a towing relation about vehicles which are only placed in the towed-vehicle placeable regions A1 and A2 that are fan-shaped regions behind the respective towing vehicles.

By setting such a towed-vehicle placeable fan-shaped region behind the towing vehicle, it is possible to restrict the number of vehicles subject to determination of a towing relation while easily determining whether or not multiple vehicles form a vehicle train, to thereby reduce the processing load of the vehicle identification device 100. Furthermore, by setting the towed-vehicle placeable fan-shaped region, it becomes possible to improve the reliability of determination of a towing relation. This is because, in many cases, a vehicle towed by a towing vehicle, or a plurality of vehicles towed by a towing vehicle in a string, is located in such a towed-vehicle placeable fan-like region.

FIG. 7 is a graph showing towing relations between the towing vehicles 1, 2 and the towed vehicles 3 to 11, determined by the vehicle identification device 100 according to Embodiment 2. The graph shows that the towed vehicles 3 to 6 have, in this order, towing relations relative to the towing vehicle 1 to form a vehicle train, and the towed vehicles 7 to 9 have, in this order, towing relations relative to the towing vehicle 2 to form a vehicle train. Here, although vehicles 10, 11 are classified as towed vehicles, they don't belong to either the vehicle train including the vehicle 1 or the vehicle train including the vehicle 2. Thus, it is shown that they have no towing relation and are thus placed independently. In FIG. 7, the presence of towing relation is indicated by a check mark and the absence of towing relation is indicated by “N.A.”.

### 3. Embodiment 3

<Towed-Vehicle Placeable Region Based on Traveled Path>

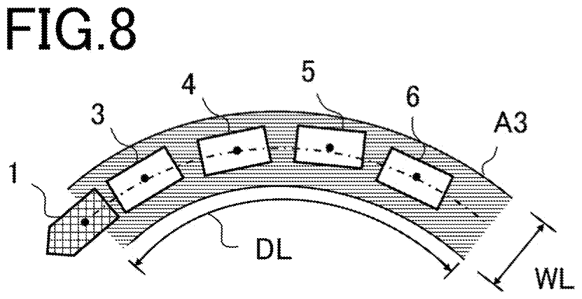

FIG. 8 is a diagram for explaining how a vehicle identification device 100 according to Embodiment 3 extracts a vehicle train and determines a towing relation. Since the vehicle identification device according to Embodiment 3 can be implemented by changing the software of the vehicle identification device according to Embodiment 1 or 2, the reference numeral 100 is also used without change for the vehicle identification device. However, the vehicle identification device according to Embodiment 3 may be implemented with a hardware change.

The vehicle identification device 100 according to Embodiment 3 determines a towing relation about a vehicle which is placed in a towed-vehicle placeable region behind the towing vehicle. The towed-vehicle placeable region is a region that is defined by a traveled path of the towing vehicle within a predetermined vehicle-train distance DL from and behind the towing vehicle; and a predetermined right-to-left width WL with respect to the traveled path.

The vehicle-train distance DL and the right-to-left width WL may be determined through actual measurement of vehicle-train distances DL and right-to-left widths WL that may be taken by a vehicle train actually having a connection in a towing state. For example, the vehicle-train distance DL may be set to 50 meters, and the right-to-left width WL may be set to 5 meters.

In FIG. 8, a vehicle train is shown that is formed of a towing vehicle 1 and vehicles 3, 4, 5, 6 behind the towing vehicle 1. A towed-vehicle placeable region A3 is shown that is defined by the traveled path of the towing vehicle 1 within the predetermined vehicle-train distance DL behind the towing vehicle; and the predetermined right-to-left width WL with respect to the traveled path. The determination of a towing relation is made about a vehicle which is placed in the towed-vehicle placeable region A3.

In this embodiment, the determination of a towing relation is made about a vehicle whose center position is placed in the towed-vehicle placeable region A3. In the determination of a towing relation, for example, if the inter-vehicle distance between a front vehicle and a rear vehicle is within the towing distance DS, the rear vehicle may be determined to be towed by the front vehicle. This makes it possible to determine a towing relation about vehicles which are placed only in the towed-vehicle placeable region A3 behind a towing vehicle.

By setting, behind the towing vehicle, the towed-vehicle placeable region A3 that is defined by the traveled path of the towing vehicle within the vehicle-train distance DL behind the towing vehicle; and the predetermined right-to-left width WL with respect to the traveled path, it is possible to restrict the number of vehicles subject to determination of a towing relation while easily determining whether or not multiple vehicles form a vehicle train, to thereby reduce the processing load of the vehicle identification device 100. Furthermore, by setting the towed-vehicle placeable region based on the traveled path of the towing vehicle, it becomes possible to improve the reliability of determination of a towing relation. This is because, in many cases, a vehicle towed by a towing vehicle, or a plurality of vehicles towed by a towing vehicle in a string, will travel along the traveled path of the towing vehicle.

### 4. Embodiment 4

<Vehicle Type (Discrimination of Carriage to be Towed)>

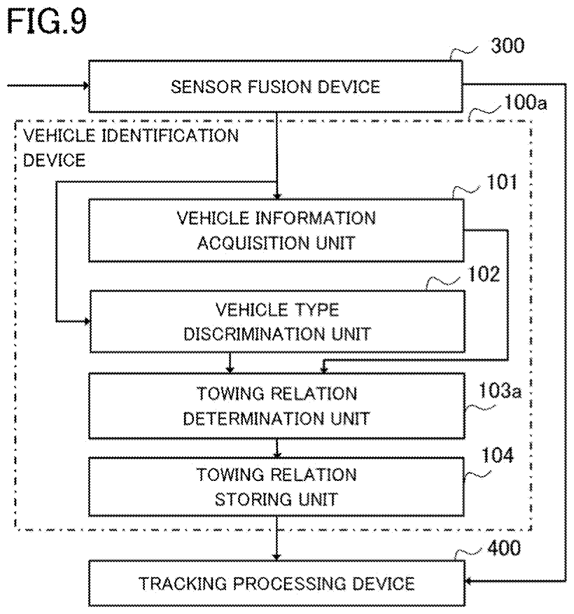

FIG. 9 is a functional block diagram of a vehicle identification device 100a according to Embodiment 4. The functional block diagram of FIG. 9 about the vehicle identification device 100a differs from the functional block diagram of FIG. 2 about the vehicle identification device 100 according to Embodiment 1, in that a vehicle type discrimination unit 102 that receives signals from the sensor fusion device 300 is added. Further, a towing relation determination unit 103a differs from the towing relation determination unit 103 in that it receives signals from the vehicle type discrimination unit 102.

The vehicle type discrimination unit 102 receives from the sensor fusion device 300, type information pertaining to respective types of the vehicles, and then discriminates the types of the vehicles on the basis of the type information. The vehicle type discrimination unit 102 transfers the data of the thus-discriminated respective types of the vehicles, to the towing relation determination unit 103a.

The type information pertaining to the types of the vehicles may be acquired by using, as a sensor, a camera for capturing an image. The type information includes information indicating whether or not the vehicle concerned is a carriage to be towed. Whether or not the vehicle is a to-be-towed carriage may be discriminated from an image of the vehicle captured by the camera. It is allowed that a discrimination mark indicating that the vehicle is a to-be-towed carriage is put beforehand on the front face, the rear face or the side face of that vehicle, and the discrimination mark is read out from the image of the camera to thereby discriminate that the vehicle is a to-be-towed carriage. Further, it is allowed that a transmitter is placed on a to-be-towed carriage and a signal indicative of a to-be-towed carriage is transmitted therefrom. By receiving the signal from the to-be-towed carriage, it is possible to discriminate that the vehicle concerned is a to-be-towed carriage.

Using the vehicle type discrimination unit 102, the towing relation of a vehicle relative to a towing vehicle may be determined only when the type of the vehicle is a to-be-towed carriage. If this is the case, the determination of a towing relation is made about a vehicle which has been found to be a to-be-towed vehicle.

This makes it possible to restrict the number of vehicles subject to determination of a towing relation to thereby reduce the processing load of the vehicle identification device 100. Furthermore, since only a towing relation with a vehicle which is revealed to be a to-be-towed vehicle, is determined, it becomes possible to improve the reliability of determination of a towing relation.

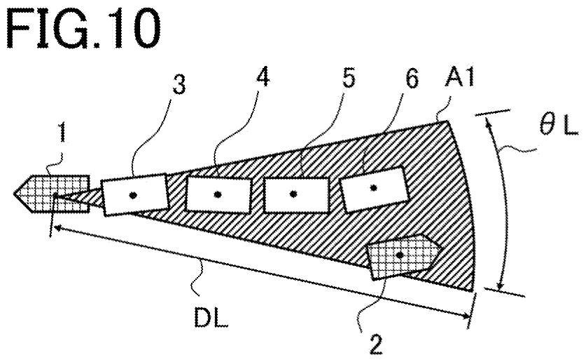

FIG. 10 is a diagram for explaining how the vehicle identification device 100a according to Embodiment 4 extracts a vehicle train and determines a towing relation. In FIG. 10, a case is assumed where a towing vehicle 1 tows vehicles 3, 4, 5, 6 each as a to-be-towed carriage. Here, like in FIG. 6 according to Embodiment 2, let's assume a case where the towed-vehicle placeable region A1 as a fan-shaped region is set behind the towing vehicle.

In FIG. 10, another vehicle 2 has intruded into the towed-vehicle placeable region A1 to closely pass a vehicle train following the towing vehicle 1. On this occasion, since the vehicle 2 is placed in the towed-vehicle placeable region A1, it is subjected to the determination of the towing relation relative to the vehicles 3, 4, 5, 6 in the vehicle train towed by the towing vehicle 1. In this case, if the determination of the towing relation is made based only on the distance to each of the other vehicles in the vehicle train, such a case is conceivable where the vehicle 2 is erroneously determined to be towed by the vehicle 6.

However, in the vehicle identification device 100a according to Embodiment 4, by the vehicle type discrimination unit 102, the types of the vehicles are discriminated as indicating that only the vehicles 3 to 6 are to-be-towed carriages, and the data of the types of the vehicles is transferred to the towing relation determination unit 103a. Then, only the vehicle 3 to 6 discriminated as to-be-towed vehicles are subjected to the determination of a towing relation with the vehicle 1. Thus, no towing relation is determined about the vehicle 2 which is traveling separately.

Accordingly, it is possible to prevent a towing relation from being determined with the other vehicle having intruded into the towed-vehicle placeable region A1. As the result, it is possible to prevent the other vehicle from being erroneously recognized as a towed vehicle.

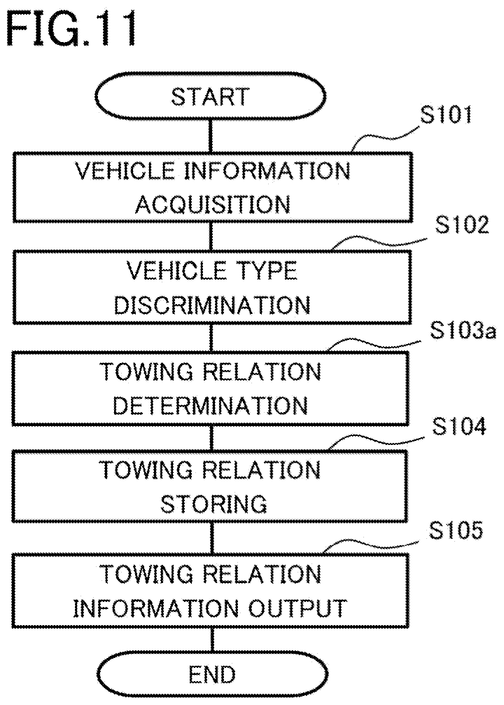

FIG. 11 is a flowchart showing operations of the vehicle identification device 100a according to Embodiment 4. The flowchart of FIG. 11 differs from the flowchart of FIG. 5 according to Embodiment 1 in that Step S102 is added next to Step S101. Further, in Step S103a, since processing is performed while additionally taking into account the data calculated in Step S102, the detail of the operation differs from the foregoing. Description will be made only about different portions of the operation, as follows.

In Step S102, the vehicle type discrimination unit 102 receives the type information pertaining to the respective types of the vehicles from the sensor fusion device 300. Then, on the basis of the type information, the vehicle type discrimination unit 102 discriminates the types of the vehicles. The vehicle type discrimination unit 102 transfers the data of thus-discriminated respective types of the vehicles to the towing relation determination unit 103a.

In Step S103a, the determination of a towing relation in the vehicles is made based on the vehicle information and the vehicle-type data. Then, the flow moves to Step S104. The subsequent operations are the same as those in the flowchart of FIG. 5.

### 5. Embodiment 5

<Determination of Towing Relation Based on Movement Conditions of Vehicle>

FIG. 12 is a diagram for explaining how a vehicle identification device 100 according to Embodiment 5 extracts a vehicle train and determines a towing relation. Here, since the vehicle identification device according to Embodiment 5 can be implemented by changing the software of the vehicle identification device according to Embodiment 1, the reference numeral 100 is also used without change for the vehicle identification device. However, the vehicle identification device according to Embodiment 5 may be implemented with a hardware change.

The vehicle identification device 100 according to Embodiment 5 determines that, in a vehicle train, a rear vehicle following a front vehicle and satisfying three conditions shown below with respect to the front vehicle, is a towed vehicle towed by the front vehicle. The first condition is that the rear vehicle is placed at a position behind and within a pre-determined towing distance DS relative to the position of the front vehicle. The second condition is that the traveling direction of the rear vehicle is within a predetermined second angular range θL2 with respect to the traveling direction of the front vehicle. The third condition is that the rear vehicle is traveling at a speed within a predetermined speed tolerance range VL with respect to the traveling speed of the front vehicle. (Note that the towing distance DS, the second angular range θL2 and the speed tolerance range VL are not indicated in the figure)

The second angular range θL2 and the speed tolerance range VL may be determined through actual measurement of angular ranges and speed tolerance ranges that may be taken by vehicles actually connected in a towing state. For example, the second angular range θL2 may be set to 30 degrees, and the speed tolerance range VL may be set to 2 km/H.

In FIG. 12, it is assumed that, relative to the position of a leading vehicle 1, the position of a rear vehicle 3 is within the towing distance DS that is set behind the leading vehicle 1. Further, it is assumed that the traveling direction of the rear vehicle 3 is within the second angular range θL2 with respect to the traveling direction of the leading vehicle 1. Furthermore, it is assumed that the rear vehicle 3 is traveling at a speed within the speed tolerance range VL with respect to the traveling speed of the leading vehicle 1. In this case, relative to the leading vehicle 1, the rear vehicle 3 is a towed vehicle and thus has a towing relation.

In addition, it is assumed that, relative to the position of the towed vehicle 3, the position of a rear vehicle 4 is within the towing distance DS that is set behind the towed vehicle 3. Further, it is assumed that the traveling direction of the rear vehicle 4 is within the second angular range θL2 with respect to the traveling direction of the towed vehicle 3. Furthermore, it is assumed that the rear vehicle 4 is traveling at a speed within the speed tolerance range VL with respect to the traveling speed of the towed vehicle 3. In this case, relative to the towed vehicle 3, the rear vehicle 4 is a towed vehicle and thus has a towing relation.

Likewise, a vehicle 5 is towed by the towed vehicle 4. Namely, the vehicle 5 has a towing relation with the towed vehicle 4. Likewise, a vehicle 6 is towed by the towed vehicle 5. Namely, the vehicle 6 has a towing relation with the towed vehicle 5.

In FIG. 12, it is assumed that, relative to the position of a leading vehicle 2, the position of a rear vehicle 7 is within the towing distance DS that is set behind the leading vehicle 2. Further, it is assumed that the traveling direction of the rear vehicle 7 is within the second angular range θL2 with respect to the traveling direction of the leading vehicle 2. Furthermore, it is assumed that the rear vehicle 7 is traveling at a speed within the speed tolerance range VL with respect to the traveling speed of the leading vehicle 2. In this case, relative to the leading vehicle 2, the rear vehicle 7 is a towed vehicle and thus has a towing relation.

In addition, it is assumed that, relative to the position of the towed vehicle 7, the position of a rear vehicle 8 is within the towing distance DS that is set behind the towed vehicle 7. Further, it is assumed that the traveling direction of the rear vehicle 8 is within the second angular range θL2 with respect to the traveling direction of the towed vehicle 7. Furthermore, it is assumed that the rear vehicle 8 is traveling at a speed within the speed tolerance range VL with respect to the traveling speed of the towed vehicle 7. In this case, relative to the towed vehicle 7, the rear vehicle 8 is a towed vehicle and thus has a towing relation.

Likewise, a vehicle 9 is towed by the towed vehicle 8. Namely, the vehicle 9 has a towing relation with the towed vehicle 8.

Let's assume a case where when, as shown in FIG. 12, the vehicle train headed by the towing vehicle 1 is going to pass the vehicle train headed by the towing vehicle 2, the towed vehicles 5, 6 become close to the towed vehicles 8, 9. On this occasion, if the determination of a towing relation is made based only on the inter-vehicle distance between vehicles, such a risk may arise that any one of the towed vehicles is erroneously recognized as a towed vehicle in the different vehicle train.

Further, let's assume a case where the determination of a towing relation is made by setting the towed-vehicle placeable regions A1, A2 as fan-shaped regions behind the respective towing vehicles. Since the towed-vehicle placeable regions A1, A2 have their overlapping portion, if any one of the towed vehicles is placed in the overlapping portion of the towed-vehicle placeable regions A1, A2, such a risk may arise that the towed vehicle is erroneously recognized as a towed vehicle in the different vehicle train.

In such cases, it is appropriate to apply restriction to the determination so that, only when a vehicle following a front vehicle satisfies the foregoing three conditions according to Embodiment 5, it is determined as a towed vehicle towed by the front vehicle. With such restriction, in a case represented by FIG. 12, even if the inter-vehicle distance between vehicles in different two vehicle trains is within the towing distance DS and a traveling speed difference therebetween is within the speed tolerance range VL, since their respective traveling directions are opposed to each other, it can be thought that the traveling direction of the rear vehicle is not placed in the second angular range θL2. Thus, it is possible to prevent the towed vehicle from being erroneously recognized as a towed vehicle in the different vehicle train.

### 6. Embodiment 6

<Stop of Updating Stored Towing Relation at Side-by-Side Travel of Vehicle Trains>

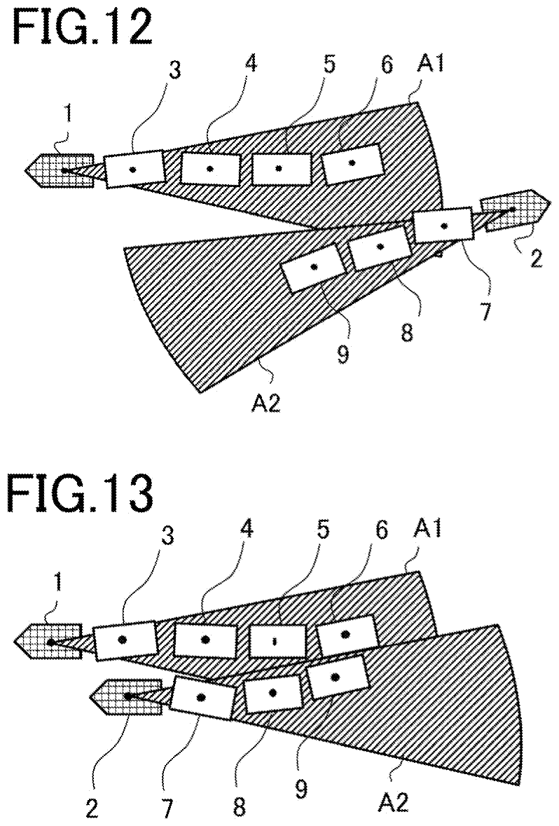

FIG. 13 is a diagram for explaining how a vehicle identification device 100 according to Embodiment 6 extracts a vehicle train and determines a towing relation. Here, since the vehicle identification device according to Embodiment 6 can be implemented by changing the software of the vehicle identification device according to Embodiment 1, the reference numeral 100 is also used without change for the vehicle identification device. However, the vehicle identification device according to Embodiment 6 may be implemented with a hardware change.

The vehicle identification device 100 according to Embodiment 6 stops updating the stored towing relation when the vehicle train and another vehicle train travel side by side with a speed difference within a predetermined second speed tolerance range VL2. (Note that the second speed tolerance range VL2 is not indicated in the figure) At this time, instead of stopping updating the stored towing relation, the device may stop determining a towing relation.

Let's assume a case where, as shown in FIG. 13, a vehicle train headed by a towing vehicle 1 and a vehicle train headed by a towing vehicle 2 travel side by side with a speed difference within the predetermined second speed tolerance range VL2. In this case, it is assumable that the positions of towed vehicles in the respective vehicle trains become close to each other, the traveling directions of these vehicles become the same, and the traveling speeds thereof are close to each other. According to this assumption, such a risk may arise that any one of the towed vehicles is erroneously recognized as a towed vehicle in the different vehicle train.

In such a case, updating the stored towing-relation determination result about the vehicles is stopped. This makes it possible to prevent storing of erroneous towing relation. The vehicle identification device 100 can prevent outputting of erroneous towing relation.

The second speed tolerance range VL2 may be determined after confirmation of conditions where a towing relation may be erroneously recognized between actual vehicle trains each having a connection in a towing state. For example, the second speed tolerance range VL2 may be set to 2 km/H.

### 7. Embodiment 7

<Update of Towing Relation at Traveling Restart of Vehicle Train After Stopping>

A vehicle identification device 100 according to Embodiment 7 can be implemented by changing the software of the vehicle identification device according to Embodiment 1 or 2, so that the reference numeral 100 is also used without change for the vehicle identification device. However, the vehicle identification device according to Embodiment 7 may be implemented with a hardware change.

In the vehicle identification device 100 according to Embodiment 7, the towing relation determination unit 103 deletes a storage content related to a towing relation stored in the towing relation storing unit 104, when, after the vehicle train passing through a stopped state, any one of the following conditions is established. A first condition is that the towed vehicle gets a position that is farther than a predetermined second towing distance DS2 from the position of the towing vehicle. (Note that the second towing distance DS2 is not indicated in the figure)

The second towing distance DS2 may be determined through actual measurement of a distance between actual vehicles connected in a towing state. When a part-transport carriage in a factory is assumed to be a target vehicle, the second towing distance DS2 may be set to 1 meter, for example.

A second condition is that the towed vehicle travels in a traveling direction that is out of a predetermined third angular range θL3 with respect to the traveling direction of the towing vehicle. A third condition is that the towed vehicle travels at a speed that is out of a predetermined third speed tolerance range VL3 with respect to the traveling speed of the towing vehicle. Any one of these conditions is established, the vehicle identification device 100 deletes the storage content related to the relation between the towing vehicle and the towed vehicle stored in the towing relation storing unit 104. (Note that the third angular range θL3 and the third speed tolerance range VL3 are not indicated in the figure) This processing is also applicable to a towed vehicle and another towed vehicle towed by that towed vehicle.

The third angular range θL3 and the third speed tolerance range VL3 may be determined through actual measurement of angular ranges and speed tolerance ranges that may be taken by vehicles actually connected in a towing state. When a part-transport carriage in a factory is assumed to be a target vehicle, the third angular range θL3 may be set to 30 degrees, and the third speed tolerance range VL3 may be set to 2 km/H, for example.

In general, separation of vehicles in a towing state or addition of a vehicle to them is made in a stopped state of the vehicle train. Thus, in order to deal with such a change in the towing state, it is a desirable way to determine the change in the towing state after the vehicle train is stopped, and then to delete the storage content related to the towing state before change. This may result in accurate recognition of a towing state and is thus useful.

In this application, a variety of exemplary embodiments and examples are described; however, every characteristic, configuration or function that is described in one or more embodiments, is not limited to being applied to a specific embodiment, and may be applied singularly or in any of various combinations thereof to another embodiment. Accordingly, an infinite number of modified examples that are not exemplified here are supposed within the technical scope disclosed in the present description. For example, such cases shall be included where at least one configuration element is modified; where any configuration element is added or omitted; and furthermore, where at least one configuration element is extracted and combined with a configuration element of another embodiment.

What is claimed is:

1. A vehicle identification device, comprising:
a vehicle information acquisitor for acquiring vehicle information indicative of positions, traveling directions and traveling speeds of multiple vehicles;
a towing relation determinator for extracting, from the vehicle information acquired by the vehicle information acquisitor, a vehicle train that is a succession of vehicles, to thereby determine that a leading vehicle in the vehicle train is a towing vehicle and a portion of the vehicle train subsequent to the towing vehicle is at least one towed vehicle towed by the towing vehicle; and
a towing relation memory for storing a towing relation represented by the towing vehicle and said at least one towed vehicle determined by the towing relation determinator.

2. The vehicle identification device of claim 1, wherein the towing relation determinator determines that a second vehicle which is placed in the vehicle train at a position behind the leading vehicle and within a predetermined towing distance relative to the position of the leading vehicle, is a towed vehicle towed by the leading vehicle.

3. The vehicle identification device of claim 2, wherein the towing relation determinator determines that a third vehicle which is placed in the vehicle train at a position behind the towed vehicle and within the towing distance relative to the position of the towed vehicle, is a second towed vehicle towed by the towed vehicle; and
wherein the towing relation memory stores a towing relation represented by the towing vehicle, the towed vehicle and the second towed vehicle determined by the towing relation determinator.

4. The vehicle identification device of claim 1, wherein the towing relation determinator determines the towing relation about a vehicle in the vehicle train which is placed in a towed-vehicle placeable region that is a region within a predetermined vehicle-train distance from and behind the towing vehicle and in a predetermined angular range behind the towing vehicle.

5. The vehicle identification device of claim 1, wherein the towing relation determinator determines the towing relation about a vehicle in the vehicle train which is placed in a towed-vehicle placeable region that is a region defined by a traveled path within a predetermined vehicle-train distance from and behind the towing vehicle; and a predetermined right-to-left width with respect to the traveled path.

6. The vehicle identification device of claim 1, further comprising a vehicle type discriminator for discriminating whether a vehicle type is a carriage to be towed,
wherein the towing relation determinator determines the towing relation about a vehicle in the vehicle train which is placed behind the towing vehicle and whose vehicle type is discriminated as the carriage to be towed, by the vehicle type discriminator.

7. The vehicle identification device of claim 1, wherein the towing relation memory stores the towing relation when the vehicle train is in a stopped state.

8. The vehicle identification device of claim 1, wherein the towing relation determinator determines that a second vehicle which is placed in the vehicle train at a position behind the leading vehicle and within a predetermined towing distance relative to the position of the leading vehicle, and which is traveling in a traveling direction within a predetermined second angular range with respect to the traveling direction of the leading vehicle, and at a speed within a predetermined speed tolerance range with respect to the traveling speed of the leading vehicle, is the towed vehicle towed by the leading vehicle.

9. The vehicle identification device of claim 8, wherein the towing relation determinator determines that a third vehicle which is placed in the vehicle train at a position behind the towed vehicle and within the towing distance relative to the position of the towed vehicle, and which is traveling in a traveling direction within the second angular range with respect to the traveling direction of the towed vehicle, and at a speed within the speed tolerance range with respect to the traveling speed of the towed vehicle, is a second towed vehicle towed by the towed vehicle.

10. The vehicle identification device of claim 1, wherein the towing relation memory stops updating the stored towing relation when the vehicle train and another vehicle train travel side by side with a speed difference within a predetermined second speed tolerance range.

11. The vehicle identification device of claim 1, wherein the towing relation determinator deletes a storage content related to the towing relation of the towing vehicle and the towed vehicle stored in the towing relation memory, when, after the vehicle train passing through a stopped state, the towed vehicle gets a position that is farther than a predetermined second towing distance from the position of the towing vehicle; the towed vehicle travels in a traveling direction that is out of a predetermined third angular range with respect to the traveling direction of the towing vehicle; or the towed vehicle travels at a speed that is out of a predetermined third speed tolerance range with respect to the traveling speed of the towing vehicle.

12. The vehicle identification device of claim 1, wherein, in cases where the towing relation memory is storing the towing relation of the towing vehicle, the towed vehicle towed by the towing vehicle and a second towed vehicle towed by the towed vehicle,
the towing relation determinator deletes a storage content related to the towing relation of the towed vehicle and the second towed vehicle stored in the towing relation memory, when, after the vehicle train passing through a stopped state, the second towed vehicle towed by the towed vehicle gets a position that is farther than a predetermined second towing distance from the position of the towed vehicle; the second towed vehicle travels in a traveling direction that is out of a predetermined third angular range with respect to the traveling direction of the towed vehicle; or the second towed vehicle travels at a speed that is out of a predetermined third speed tolerance range with respect to the traveling speed of the towed vehicle.
